(19) United States
(12) Patent Application Publication
(10) Pub. No.: US 2011/0287108 A1
(43) Pub. Date: Nov. 24, 2011

(54) PESTICIDE COMPOSITION COMPRISING A TETRAZOLYLOXIME DERIVATIVE AND A FUNGICIDE OR AN INSECTICIDE ACTIVE SUBSTANCE

(75) Inventors: Pierre-Yves Coqueron, Lyon (FR); Ulrike Wachendorf-Neumann, Neuwied (DE)

(73) Assignee: BAYER CROPSCIENCE AG, Monheim (DE)

(21) Appl. No.: 13/131,797

(22) PCT Filed: Nov. 27, 2009
(86) PCT No.: PCT/EP2009/065957

§ 371 Date: Aug. 10, 2011

(30) Foreign Application Priority Data
Nov. 28, 2008 (EP) 08356147.2

(51) Int. Cl. A01N 59/26; A01N 43/84; A01P 7/04; A01N 57/12; A01P 3/00; A01N 43/713; A01N 59/20

(52) U.S. Cl. 424/605; 514/340; 514/237.5; 424/632; 514/141

(57) ABSTRACT

The present invention relates to a pesticide composition intended for protecting plants, crops or seeds against fungal diseases or insect damages, and the corresponding methods of protection by application of the said composition. More precisely, the subject of the present invention is a pesticide composition based on a tetrazolyloxime derivative and a fungicide or an insecticide active substance or compound.

The present invention relates to a pesticide composition intended for protecting plants, crops or seeds against fungal diseases or insect damages, and the corresponding methods of protection by application of the said composition. More precisely, the subject of the present invention is a pesticide composition based on a tetrazolyloxime derivative and a fungicide or an insecticide active substance or compound.

As regards pesticide activity, in particular for the protection of crops, one of the problems at the heart of the research studies carried out in this technical field is the improvement of performances, in particular in terms of biological activity and in particular in terms of maintaining such an activity over time.

The present invention provides a pesticide composition which can be used, in particular by the farmer, for controlling the pest infesting crops and in particular for controlling insects or diseases.

The pesticide compounds useful for the protection of plants must be endowed with an ecotoxicity which is reduced to the minimum. As far as possible, they should not be dangerous or toxic to the operator during use. The economic factor should of course not be overlooked in the search for novel pesticide agents.

The present invention advantageously provides a pesticide composition which is completely high-performing in particular as regards its efficacy against pests and the perennially of this efficacy so as to be able to reduce the doses of chemical products spread in the environment for combating pest damages or attacks of plants or crops.

The invention provides a pesticide composition capable to be more active and active for longer, and which therefore has a lower dose, but which is also less toxic, in particular in the treatment of plants and particularly the foliar and seed treatments of fungal diseases or the control of insects, for example, of cereals, cotton, peanut, bean, beet, canola, Solanaceae, grapevine, vegetables, lucerne, soybean, market garden crops, turf, wood or horticultural plants.

The composition according to the invention allows controlling a broad variety of insects or fungi. For example, the pesticide composition according to the invention exhibits an improved efficacy against fungus like Plasmodiophoromycetes, Oomycetes, Chytridiomycetes, Zygomycetes, Basidiomycetes, Deuteromycetes and Ascomycetes.

All these objectives or advantages, among others, were achieved by finding a pesticide composition comprising a tetrazolyloxime derivative and a fungicide or an insecticide compound. Such a composition surprisingly and unexpectedly allows a very high and perennial anti-fungal or insecticide efficacy against a broad spectrum of insects or fungi and in particular against those responsible for diseases or damages of crops. Other insect pests or diseases of crops can be controlled with the pesticide composition according to the invention.

The pesticide composition according to the invention may also be used for the treatment of bacterial or virus diseases.

Insects or nematodes that can be controlled with the pesticide composition according to the invention include a broad variety of these damaging organisms.

In patent application US-2005/0070439 there are disclosed certain tetrazolyloxime derivatives. The possibility to mix said compounds with other chemicals is generally mentioned. However, there is no specific disclosure in this document of any combination comprising said tetrazolyloxime derivatives with a fungicide or an insecticide compound.

In a main aspect, the present invention provides a composition comprising:
A) a tetrazolyloxime derivative of formula (I)

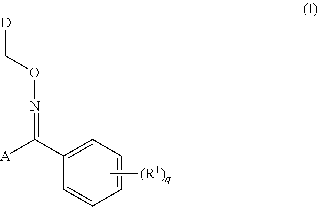

wherein
R¹ represents a hydrogen atom, a halogen atom, a substituted or non-substituted C₁-C₆-alkyl, a substituted or non-substituted C₁-C₆-alkoxy, nitro, cyano, a substituted or non-substituted C₁-C₆-aryl or a substituted or non-substituted C₁-C₆-alkylsulphonyl;
q represents 0, 1, 2, 3, 4 or 5;
A represents a tetrazoyl group of formula (A¹) or (A²):

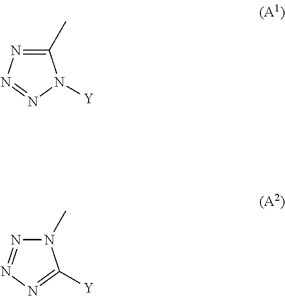

wherein Y represents an C₁-C₆-alkyl group; and
D represents a pyridyl group of formula (D¹) or a thiazolyl group of formula (D²);

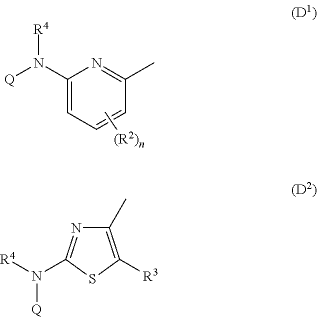

wherein R² and R³ independently represent a hydrogen atom, a halogen atom, a substituted or non-substituted C₁-C₆-alkyl, a substituted or non-substituted C₁-C₆-alkoxy, substituted or non-substituted C₁-C₆-alkylthio, substituted or non-substituted amino, a substituted or non-substituted C₁-C₆-aryl;
n represents 0, 1, 2 or 3;
R⁴ represents a hydrogen atom, a formyl, a substituted or non-substituted C₁-C₆-alkylcarbonyl, a substituted or non-substituted C₁-C₆-haloalkylalkylcarbonyl comprising between one and 9 halogen atoms, a substituted or non-substituted C₁-C₆-alkoxycarbonyl;
Q represents a substituted or non-substituted C₁-C₂₀-alkyl, a substituted or non-substituted C₂-C₂₀-alkenyl, a substituted or non-substituted C₂-C₂₀-alkynyl, a substituted or non-substituted C₃-C₈-cycloalkyl, substituted or non-substituted aryl-[C₁-C₈]-alkyl, substituted or non-substituted, saturated or unsaturated 4-, 5-, 6- or 7-membered heterocyclyl-[C₁-C₈]-alkyl comprising up to 4 heteroatoms selected in the list consisting of N, O, S;
as well as salts, N-oxides, metallic complexes and metalloidic complexes thereof or (E) and (Z) isomers and mixtures thereof
and
B) a fungicide compound in an NB weight ratio ranging from 0.001/1 to 1/1,000.

Any of the compounds according to the invention can exist as one or more stereoisomers depending on the number of stereogenic units (as defined by the IUPAC rules) in the compound. The invention thus relates equally to all the stereoisomers, and to the mixtures of all the possible stereoisomers, in all proportions. The stereoisomers can be separated according to the methods which are known per se by the man ordinary skilled in the art.

Notably, the stereostructure of the oxime moiety present in the heterocyclyloxime derivative of formula (I) includes (E) or (Z) isomer, and these stereoisomers form part of the present invention.

According to the invention, the following generic terms are generally used with the following meanings:
halogen means fluorine, chlorine, bromine or iodine;
heteroatom can be nitrogen, oxygen or sulphur;
unless indicated otherwise, a group or a substituent that is substituted according to the invention can be substituted by one or more of the following groups or atoms: a halogen atom, a nitro group, a hydroxy group, a cyano group, an isocyano group, an isocyanate group, an thiocyanate group, an amino group, a sulphenyl group, a formyl group, a formyloxy group, a carbamoyl group, a C₁-C₈-alkyl, a C₁-C₈-halogenoalkyl having 1 to 5 halogen atoms, a C₂-C₈-alkenyl, a C₂-C₈-alkynyl, a C₂-C₈-alkenyloxy, a C₁-C₈-alkylamino, a di-C₁-C₈-alkylamino, a phenylamino, a benzylamino, a phenethylamino, a C₁-C₈-alkoxy, a C₁-C₈-halogenoalkoxy having 1 to 5 halogen atoms, a C₁-C₈-alkylsulphenyl, a C₁-C₈-alkylcarbonyl, a C₁-C₈-alkylthiocarbonyl, a C₁-C₈-alkylcarbamoyl, a di-C₁-C₈-alkylcarbamoyl, a C₁-C₈-alkoxycarbonyl, a C₁-C₈-alkylcarbonyloxy, a C₁-C₈-alkylcarbonylamino, C₁-C₈-alkoxycarbonylamino, a C₁-C₈-alkylsulphenyl, a C₁-C₈-alkylsulphonyl, a C₂-C₈-alkenylsulphonyl, a C₃-C₈-alkynyl-sulphonyl, arylsulphonyl, saturated or unsaturated 4-, 5-, 6- or 7-membered heterocyclylsulphonyl, aryl-[C₁-C₈]-alkylsulphonyl, a C₁-C₈-alkylsulfamoyl, a C₁-C₈-halogenoalkyl sulfamoyl having 1 to 5 halogen atoms, a N-di(C₁-C₈-alkyl)sulfamoyl, a N-di(C₁-C₈-halogenoalkyl) sulfamoyl having 1 to 5 halogen atoms, arylsulfamoyl, saturated or unsaturated 4-, 5-, 6- or 7-membered heterocyclylsulfamoyl aryl-[C₁-C_{$}]-alkyl, or unsaturated 4-, 5-, 6- or 7-membered heterocyclyl-[C₁-C₈]-alkyl comprising up to 4 heteroatoms selected in the list consisting of N, O, S, aryl-[C₁-C₈]-alkoxy, aryloxy, aryl, (C₁-C₈-alkylimino)-C₁-C₈-alkyl, saturated or unsaturated 4-, 5-, 6- or 7-membered heterocyclyl, aryl-[C₁-C₈]-alkylthio, arylthio, saturated or unsaturated 4-, 5-, 6- or 7-membered heterocyclylthio;
the term “aryl” means phenyl or naphthyl.

In a further aspect, the present invention provides a composition comprising:
A) a tetrazolyloxime derivative of formula (I) wherein formula (I) is as herein-defined;
B) a fungicide compound and
C) a second further fungicide compound in an A/B/C weight ratio ranging from 0.001/0.001/1 to 1/1,000/1,000.

to Still in a further aspect, the present invention provides a composition comprising:
A) a tetrazolyloxime derivative of formula (I) wherein formula (I) is as herein-defined;
B) a fungicide compound and
D) an insecticide compound in an A/B/D weight ratio ranging from 0.001/0.001/1 to 1/1,000/1,000.

Still in a further aspect, the present invention provides a composition comprising:
A) a tetrazolyloxime derivative of formula (I) wherein formula (I) is as herein-defined; and
D) an insecticide compound in an ND weight ratio ranging from 1/1,000 to 1,000/1.

Still in a further aspect, the present invention provides a composition comprising:
A) a tetrazolyloxime derivative of formula (I) wherein formula (I) is as herein-defined;
B) a fungicide compound;
C) a second further fungicide compound and
D) an insecticide compound in an A/B/C/D weight ratio ranging from 0.001/0.001/0.001/1 to 1/1,000/1,000/1,000.

In the tetrazolyloxime derivative of formula (I), the substitution position of R¹ is not specifically limited and R¹ represents preferentially a hydrogen atom, a halogen atom, a substituted or non-substituted C₁-C₆-alkyl, a substituted or non-substituted C₁-C₆-alkoxy.

The alkyl group represented for R¹ is preferably an alkyl group having 1 to 4 carbon atoms and specific examples thereof include a methyl group, an ethyl group, a n-propyl group, an isopropyl group, a n-butyl group, an isobutyl group, a sec-butyl group, and a tert-butyl group. Among these alkyl groups, a methyl group or a tert-butyl group is particularly preferred.

The C₁-C₆-alkoxy group for R¹ is preferably alkoxy group having 1 to 3 carbon atoms and specific examples thereof include a methoxy group, an ethoxy group, a propoxy group, and an isopropoxy group. Among these alkoxy groups, a methoxy group or an ethoxy group is particularly preferred.

R¹ represents more preferentially a hydrogen atom or a halogen atom.

In the tetrazoyl group of formula (A¹) or (A²), Y represents an alkyl group. Among these alkyl groups, an alkyl group having 1 to 3 carbon atoms such as a methyl group, an ethyl group, a n- to propyl group or an isopropyl group is preferable. Among these alkyl groups, a methyl group or an ethyl group is particularly preferred.

R² and R³ independently represent preferentially a hydrogen atom or a halogen atom.

R⁴ represents preferentially a hydrogen atom.

Q represents preferentially a substituted or non-substituted C₁-C₂₀-alkyl, a substituted or non-substituted C₂-C₂₀-alkenyl, a substituted or non-substituted C₂-C₂₀-alkynyl, a substituted or non-substituted C₃-C₈-cycloalkyl, a substituted or non-substituted aryl-[C₁-C₈]-alkyl.

The C₁-C₂₀-alkyl group for Q is preferably an alkyl group having 1 to 8 carbon atoms and preferred compounds thereof include a methyl group, an ethyl group, an n-propyl group, an isopropyl group, a 1,1-dimethylpropyl group, a n-butyl group, an isobutyl group, a sec-butyl group, a tert-butyl group, an isoamyl group, a 1-methylbutyl group, a 2-methylbutyl group, an neopentyl group, a 1-ethylpropyl group, an n-pentyl group, a n-hexyl group, a n-heptyl group, and an n-octyl group.

The aryl-[C₁-C₈]-alkyl group for Q is preferably a benzyl group and a phenethyl group.

Among the compounds of formula (I), preferred is a tetrazolyloxime derivative wherein Q represents an alkyl group having 3 to 8 carbon atoms and D represents a pyridyl group of formula (D¹) as defined herein or a thiazoyl group of formula (D²) as defined herein, and particularly preferred is a tetrazolyloxime derivative wherein R¹ represents a hydrogen atom or a halogen atom.

The stereostructure of the oxime moiety present in the tetrazolyloxime derivative of formula (I) includes (E) or (Z) isomer, and these stereoisomers form part of the present invention. The synthesized product is generally obtained in the form of the (Z) isomer or a mixture of (E) and (Z) isomers, each of which can be isolated by separation or purification.

In the tetrazolyloxime derivative of formula (I), the (Z) isomer is particularly superior to the (E) isomer in plant disease controlling activity. However, both the (E) isomer and the (Z) isomer generally exist in a fixed ratio in the form of a mixture since the (Z) isomer is generally converted into the (E) isomer by light in a natural environment. The stable ratios of the (E) and (Z) isomers vary according to the type of compound.

For the different aspects of the composition according to the invention, fungicide compounds B and C can be independently selected in the list consisting of:

(B1) Inhibitors of the nucleic acid synthesis, for example benalaxyl, benalaxyl-M, bupirimate, clozylacon, dimethirimol, ethirimol, furalaxyl, hymexazol, metalaxyl, metalaxyl-M, ofurace, oxadixyl and oxolinic acid.
(B2) Inhibitors of the mitosis and cell division, for example benomyl, carbendazim, chlorfenazole, diethofencarb, ethaboxam, fuberidazole, pencycuron, thiabendazole, thiophanate, thiophanate-methyl and zoxamide.
(B3) Inhibitors of the respiration, for example diflumetorim as CI-respiration inhibitor; bixafen, boscalid, carboxin, fenfuram, flutolanil, fluopyram, furametpyr, furmecyclox, isopyrazam (9R-component), isopyrazam (9S-component), mepronil, oxycarboxin, penthiopyrad, sedaxane, thifluzamide as CII-respiration inhibitor; amisulbrom, azoxystrobin, cyazofamid, dimoxystrobin, enestroburin, famoxadone, fenamidone, fluoxastrobin, kresoxim-methyl, metominostrobin, orysastrobin, picoxystrobin, pyraclostrobin, pyribencarb, trifloxystrobin as CIII-respiration inhibitor.
(B4) Compounds capable to act as an uncoupler, like for example binapacryl, dinocap, fluazinam and meptyldinocap.
(B5) Inhibitors of the ATP production, for example fentin acetate, fentin chloride, fentin hydroxide, and silthiofam.
(B6) Inhibitors of the amino acid and/or protein biosynthesis, for example andoprim, blasticidin-S, cyprodinil, kasugamycin, kasugamycin hydrochloride hydrate, mepanipyrim and pyrimethanil.
(B7) Inhibitors of the signal transduction, for example fenpiclonil, fludioxonil and quinoxyfen.
(B8) Inhibitors of the lipid and membrane synthesis, for example biphenyl, chlozolinate, edifenphos, etridiazole, iodocarb, iprobenfos, iprodione, isoprothiolane, procymidone, propamocarb, propamocarb hydrochloride, pyrazophos, tolclofos-methyl and vinclozolin.
(B9) Inhibitors of the ergosterol biosynthesis, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, viniconazole and voriconazole.
(B10) Inhibitors of the cell wall synthesis, for example benthiavalicarb, dimethomorph, flumorph, iprovalicarb, mandipropamid, polyoxins, polyoxorim, prothiocarb, validamycin A, and valiphenal.
(B11) Inhibitors of the melanine biosynthesis, for example carpropamid, diclocymet, fenoxanil, phthalide, pyroquilon and tricyclazole.
(B12) Compounds capable to induce a host defence, like for example acibenzolar-5-methyl, probenazole, and tiadinil.
(B13) Compounds capable to have a multisite action, like for example bordeaux mixture, captafol, captan, chlorothalonil, copper naphthenate, copper oxide, copper oxychloride, copper preparations such as copper hydroxide, copper sulphate, dichlofluanide, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulphur and sulphur preparations including calcium polysulphide, thiram, tolylfluanid, zineb and ziram.
(B14) Further compounds like for example 2,3-dibutyl-6-chlorothieno[2,3-d]pyrimidin-4(3H)-one, ethyl (2Z)-3-amino-2-cyano-3-phenylprop-2-enoate, N-[2-(1,3-dimethylbutyl)phenyl]-5-fluoro-1,3-dimethyl-1H-pyrazole-4-carboxamide, 3-(difluoromethyl)-1-methyl-N-(3′,4′,5′-trifluorobiphenyl-2-yl)-1H-pyrazole-4-carboxamide, 3-(difluoromethyl)-N-[4-fluoro-2-(1,1,2,3,3,3-hexafluoroprop oxy)phenyl]-1-methyl-1H-pyrazole-4-carboxamide, (2E)-2-(2-{[6-(3-chloro-2-methylphenoxy)-5-fluoropyrimidin-4-yl]oxy}phenyl)-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, N-(3-ethyl-3,5,5-trimethylcyclohexyl)-3-(formylamino)-2-hydroxybenzamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N-ethyl-N-methyl-N′-{2-methyl-5-(trifluoromethyl)-4-[3-(trimethylsilyl)propoxy]phenyl}imidoformamide, N′-{5-(difluoromethyl)-2-methyl-4-[3-(trimethylsilyl)propoxy]phenyl}-N-ethyl-N-methylimidoformamide, 0-{1-[(4-methoxyphenoxy)methyl]-2,2-dimethylpropyl}1H-imidazole-1-carbothioate, N-[2-(4-{[3-(4-chlorophenyl)prop-2-yn-1-yl]oxy}-3-methoxyphenyl)ethyl]-N²-(methylsulfonyl)valinamide, 5-chloro-7-(4-methylpiperidin-1-yl)-6-(2,4,6-trifluorophenyl)[1,2,4]triazolo[1,5-a]pyrimidine, 5-amino-1,3,4-thiadiazole-2-thiol, propamocarb-fosetyl, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methylsulfonyl)pyridine, 2-butoxy-6-iodo-3-propyl-4H-chromen-4-one, 2-phenylphenol and salts, 3-(difluoromethyl)-1-methyl-N-[2-(1,1,2,2-tetrafluoroethoxy)phenyl]-1H-pyrazole-4-carboxamide, 3,4,5-trichloropyridine-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, quinolin-8-ol, quinolin-8-ol sulfate (2:1) (salt), 5-methyl-6-octyl-3,7-dihydro[1,2,4]triazolo[1,5-a]pyrimidin-7-amine, 5-ethyl-6-octyl-3,7-dihydro[1,2,4]triazolo[1,5-a]pyrimidin-7-amine, benthiazole, bethoxazin, capsimycin, carvone, chinomethionat, chloroneb, cufraneb, cyflufenamid, cymoxanil, cyprosulfamide, dazomet, debacarb, dichlorophen, diclomezine, dicloran, difenzoquat, difenzoquat methylsulphate, diphenylamine, ecomate, ferimzone, flumetover, fluopicolide, fluoroimide, flusulfamide, flutianil, fosetyl-aluminium, fosetyl-calcium, fosetyl-sodium, hexachlorobenzene, irumamycin, isotianil, methasulfocarb, methyl (2E)-2-{2-[({cyclopropyl[(4-methoxyphenyl)imino]methyl}thio)methyl]phenyl}-3-methoxyacrylate, methyl isothiocyanate, metrafenone, (5-chloro-2-methoxy-4-methylpyridin-3-yl)(2,3,4-trimethoxy-6-methylphenyl)methanone, mildiomycin, tolnifanide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(Z)-[(cyclopropylmethoxy)imino][6-(difluoromethoxy)-2,3-difluorophenyl]methyl}-2-phenylacetamide, N-{(E)-[(cyclopropylmethoxy)imino][6-(difluoromethoxy)-2,3-difluorophenyl]methyl}-2-phenylacetamide, natamycin, nickel dimethyldithiocarbamate, nitrothal-isopropyl, octhilinone, oxamocarb, oxyfenthin, pentachlorophenol and salts, phenazine-1-carboxylic acid, phenothrin, phosphorous acid and its salts, propamocarb fosetylate, propanosine-sodium, proquinazid, pyrrolnitrine, quintozene, S-prop-2-en-1-yl 5-amino-2-(1-methylethyl)-4-(2-methylphenyl)-3-oxo-2,3-dihydro-1H-pyrazole-1-carbothioate, tecloftalam, tecnazene, triazoxide, trichlamide, 5-chloro-N′-phenyl-N′-prop-2-yn-1-ylthiophene-2-sulfonohydrazide, zarilamid, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, 3-(difluoromethyl)-N-[4-fluoro-2-(1,1,2,3,3,3-hexafluoroprop oxy)phenyl]-1-methyl-1H-pyrazole-4-carboxamide, N-[2-(1,3-dimethyl-butyl)-phenyl]-5-fluoro-1,3-dimethyl-1H-pyrazole-4-carboxamide, and pentyl {6-[({[(1-methyl-1H-tetrazol-5-yl)(phenyl)methylidene]amino}oxy)methyl]pyridin-2-yl}carbamate.

For the composition according to the invention, preferred fungicide compounds B and C are independently selected in the list consisting of:
(B3) azoxystrobin, boscalid, cyazofamid, fenamidone, fluoxastrobin, pyraclostrobin, trifloxystrobin;
(B4) fluazinam;
(B7) fludioxonil;
(B8) iprodione, propamocarb, propamocarb hydrochloride;
(B9) prothioconazole, tebuconazole, triadimenol;
(B10) benthiavalicarb, iprovalicarb, mandipropamid;
(B13) chlorothalonil, folpet, mancozeb, propineb;
(B14) cymoxanil, fluopicolide, fosetyl-aluminium, propamocarb-fosetylate, bixafen also known as N-(3′,4′-dichloro-5-fluorobiphenyl-2-yl)-3-(difluoromethyl)-1-methyl-1H-pyrazole-4-carboxamide, fluopyram also known as N-{2-[3-chloro-5-(trifluoromethyl)pyridin-2-yl]ethyl}-2-(trifluoromethyl)benzamide and N-[2-(1,3-dimethyl-butyl)-phenyl]-5-fluoro-1,3-dimethyl-1H-pyrazole-4-carboxamide.

For the different aspects of the composition according to the invention, insecticide compound D is preferably selected in the list consisting of:

(D1) Acetylcholinesterase (AChE) inhibitors, for example carbamates, e.g. alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, and xylylcarb; or organophosphates, e.g. acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl, O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, and imicyafos.
(D2) GABA-gated chloride channel antagonists, for example
organochlorines, e.g. camphechlor, chlordane, endosulfan, gamma-HCH, HCH, heptachlor, lindane, and methoxychlor; or
fiproles (phenylpyrazoles), e.g. acetoprole, ethiprole, fipronil, pyrafluprole, pyriprole, and vaniliprole.
(D3) Sodium channel modulators/voltage-dependent sodium channel blockers, for example
pyrethroids, e.g. acrinathrin, allethrin (d-cis-trans, d-trans), beta-cyfluthrin, bifenthrin, bioallethrin, bioallethrin S-cyclopentyl isomer, bioethanomethrin, biopermethrin, bioresmethrin, chlovaporthrin, cis-cypermethrin, cis-resmethrin, cis-permethrin, clocythrin, cycloprothrin, to cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrin (pyrethrum), eflusilanat; DDT; methoxychlor.
(D4) Nicotinergic acetylcholine receptor agonists/antagonists, for example
chloronicotinyls, e.g. acetamiprid, clothianidin, dinotefuran, imidacloprid, imidaclothiz, nitenpyram, nithiazine, thiacloprid, thiamethoxam, AKD-1022, nicotine, bensultap, cartap, thiosultap-sodium, and thiocylam.
(D5) Allosteric acetylcholine receptor modulators (agonists), for example spinosyns, e.g. spinosad and spinetoram.
(D6) Chloride channel activators, for example mectins/macrolides, e.g. abamectin, emamectin, emamectin benzoate, ivermectin, lepimectin, and milbemectin; or juvenile hormone analogues, e.g. hydroprene, kinoprene, methoprene, epofenonane, triprene, fenoxycarb, pyriproxifen, and diofenolan.
(D7) Active ingredients with unknown or non-specific mechanisms of action, for example
gassing agents, e.g. methyl bromide, chloropicrin and sulfuryl fluoride;
selective antifeedants, e.g. cryolite, pymetrozine, pyrifluquinazon and flonicamid; or
mite growth inhibitors, e.g. clofentezine, hexythiazox, etoxazole.
(D8) Oxidative phosphorylation inhibitors, ATP disruptors, for example
diafenthiuron; organotin compounds, e.g. azocyclotin, cyhexatin and fenbutatin oxide; or
propargite, tetradifon.
(D9) Oxidative phoshorylation decouplers acting by interrupting the H proton gradient, for example chlorfenapyr, binapacryl, dinobuton, dinocap and DNOC.
(D10) Microbial disruptors of the insect gut membrane, for example Bacillus thuringiensis strains.
(D11) Chitin biosynthesis inhibitors, for example benzoylureas, e.g. bistrifluoron, chlorfluazuron, diflubenzuron, fluazuron, flucycloxuron, flufenoxuron, hexaflumuron, lufenuron, novaluron, noviflumuron, penfluoron, teflubenzuron or triflumuron.

### (D12) Buprofezin.

(D13) Moulting disruptors, for example cyromazine.
(D14) Ecdysone agonists/disruptors, for example diacylhydrazines, e.g. chromafenozide, halofenozide, methoxyfenozide, tebufenozide, and Fufenozide (JS118); or azadirachtin.
(D15) Octopaminergic agonists, for example amitraz.
(D16) Site III electron transport inhibitors/site II electron transport inhibitors, for example hydramethylnon; acequinocyl; fluacrypyrim; or cyflumetofen and cyenopyrafen.
(D17) Electron transport inhibitors, for example site I electron transport inhibitors, from the group of the METI acaricides, e.g. fenazaquin, fenpyroximate, pyrimidifen, pyridaben, tebufenpyrad, tolfenpyrad, and rotenone; or voltage-dependent sodium channel blockers, e.g. indoxacarb and metaflumizone.
(D18) Fatty acid biosynthesis inhibitors, for example tetronic acid derivatives, e.g. spirodiclofen and spiromesifen; or tetramic acid derivatives, e.g. spirotetramat.
(D19) Neuronal inhibitors with unknown mechanism of action, e.g. bifenazate.
(D20) Ryanodine receptor effectors, for example diamides, e.g. flubendiamide, (R),(S)-3-chloro-N¹-{2-methyl-4-[1,2,2,2-tetrafluoro-1-(trifluoromethyl)ethyl]phenyl}-N²-(1-methyl-2-methylsulphonylethyl)phthalamide, chlorantraniliprole (Rynaxypyr), or Cyantraniliprole (Cyazypyr).
(D21) Further active ingredients with unknown mechanism of action, for example amidoflumet, benclothiaz, benzoximate, bromopropylate, buprofezin, chinomethionat, chlordimeform, chlorobenzilate, clothiazoben, cycloprene, dicofol, dicyclanil, fenoxacrim, fentrifanil, flubenzimine, flufenerim, flutenzin, gossyplure, japonilure, metoxadiazone, petroleum, to potassium oleate, pyridalyl, sulfluramid, tetrasul, triarathene or verbutine; or one of the following known active compounds
4-{[(6-brompyrid-3-yl)methyl](2-fluorethyl)amino}furan-2(5H)-on (known from WO 2007/115644), 4-{[(6-fluorpyrid-3-yl)methyl](2,2-difluorethyl)amino}furan-2(5H)-on (known from WO 2007/115644), 4-{[(2-chlor-1,3-thiazol-5-yl)methyl](2-fluorethyl)amino}furan-2(5H)-on (known from WO 2007/115644), 4-{[(6-chlorpyrid-3-yl)methyl](2-fluorethyl)amino}furan-2(5H)-on (known from WO 2007/115644), 4-{[(6-chlorpyrid-3-yl)methyl](2,2-difluorethyl)amino}furan-2(5H)-on known from WO 2007/115644), 4-{[(6-chlor-5-fluorpyrid-3-yl)methyl](methyl)amino}furan-2(5H)—on (known from WO 2007/115643), 4-{[(5,6-dichlorpyrid-3-yl)methyl](2-fluorethyl)amino}furan-2(5H)-on (known from WO 2007/115646), 4-{[(6-chlor-5-fluorpyrid-3-yl)methyl](cyclopropyl)amino}furan-2(5H)-on (known from WO 2007/115643), 4-{[(6-chlorpyrid-3-yl)methyl](cyclopropyl)amino}furan-2(5H yon (known from EP-A-0 539 588), 4-{[(6-chlorpyrid-3-yl)methyl](methyl)amino}furan-2(5H)-on (known from EP-A-0 539 588), [(6-chlorpyridin-3-yl)methyl](methyl)oxido-λ⁴-sulfanylidencyanamid (known from WO 2007/149134), [1-(6-chlorpyridin-3-yl)ethyl](methyl)oxido-λ⁴-sulfanylidencyanamid (known from WO 2007/149134) and its diastereomeres (A) and (B)

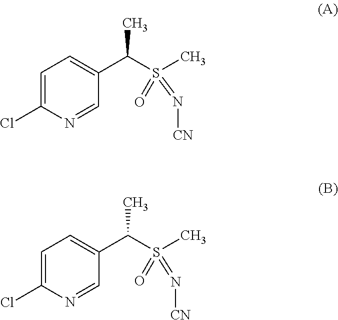

(also known from WO 2007/149134), [(6-trifluormethylpyridin-3-yl)methyl](methyl)oxido-λ⁴-sulfanylidencyanamid (known from WO 2007/095229), or [1-(6-trifluormethylpyridin-3-yl)ethyl](methyl)oxido-λ⁴-sulfanylidencyanamid (known from WO 2007/149134) and its diastereomeres (C) and (D), namely Sulfoxaflor

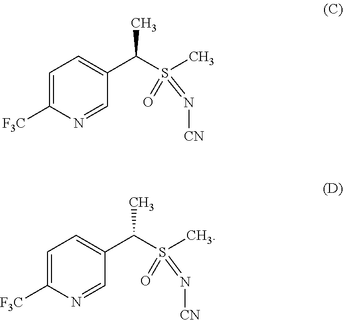

(also known from WO 2007/149134).

The active ingredients specified in this description by their “common name” are known, for example, from “The Pesticide Manual”, 13th Ed., British Crop Protection Council 2003, and from the Web page http://www.alanwood.net/pesticides.

For the various aspects of the composition according to the invention, more preferred insecticide compounds are selected in the list consisting of imidacloprid and clothianidin.

For the composition according to the invention, the NB weight ratio preferably ranges from 1/0.01 to 1/100; more preferably from 1/0.05 to 1/80.

For the composition according to the invention, the A/B/C or A/B/D weight ratio preferably ranges from 1/0.01/0.01 to 1/100/100; more preferably from 1/0.05/0.05 to 1/80/80.

For the composition according to the invention, the A/B/C/D weight ratio preferably ranges from 1/0.01/0.01/0.1 to 1/100/100/100; more preferably from 1/0.05/0.05/0.5 to 1/80/80/80.

Particular compositions according to the invention are defined as combining all or part of:
preferred oxime compounds of formula (I) as herein-defined;
preferred fungicide compounds B;
preferred fungicide compounds C;
preferred insecticide compounds D;
preferred weight ratios of active substances.

According to another aspect of the present invention, in the pesticide composition according to the invention, the compound ratio NB can be advantageously selected so as to produce a synergistic effect. The term synergistic effect is understood to mean in particular that defined by Colby in an article entitled “Calculation of the synergistic and antagonistic responses of herbicide combinations” Weeds, (1967), 15, pages 20-22.

The latter article mentions the formula:

$$E = X + Y - \frac{XY}{100}$$

wherein E represents the expected percentage of inhibition of the pest for the combination of the two compounds at defined doses (for example equal to x and y respectively), X is the percentage of inhibition observed for the pest by compound A at a defined dose (equal to x), Y is the percentage of inhibition observed for the pest by compound B at a defined dose (equal to y). When the percentage of inhibition observed for the combination is greater than E, there is a synergistic effect.

The term “synergistic effect” also means the effect defined by application of the Tammes method, “Isoboles, a graphic representation of synergism in pesticides”, Netherlands Journal of Plant Pathology, 70 (1964), pages 73-80.

According to another aspect of the present invention, in the pesticide composition according to the invention, the compound ratio A/B/C can be advantageously selected so as to produce a synergistic effect. The term synergistic effect is understood to mean in particular that defined by Colby in an article entitled “Calculation of the synergistic and antagonistic responses of herbicide combinations” Weeds, (1967), 15, pages 20-22.

The latter article mentions the formula:

$$E = X + Y + Z - \frac{XYZ}{100}$$

wherein E represents the expected percentage of inhibition of the pest for the combination of the three compounds at defined doses (for example equal to x, y and z respectively), X is the percentage of inhibition observed for the pest by compound A at a defined dose (equal to x), Y is the percentage of inhibition observed for the pest by compound B at a defined dose (equal to y) and Z is the percentage of inhibition observed for the pest by compound C at a defined dose (equal to z). When the percentage of inhibition observed for the combination is greater than E, there is a synergistic effect.

The term “synergistic effect” also means the effect defined by application of the Tammes method, “Isoboles, a graphic representation of synergism in pesticides”, Netherlands Journal of Plant Pathology, 70 (1964), pages 73-80.

Synergistic compositions comprising further active substances also form part of the present invention, the associated synergistic effect can be evidenced in a similar manner.

The pesticide composition according to the invention may comprise from 0.00001 to 100%, preferably from 0.001 to 80%, of active compounds, whether these compounds are combined or whether they are in the form of two or more active ingredients used separately.

More generally, the pesticide composition according to the invention may eventually also comprise one or more other active substances selected from fungicide, herbicide, insecticide or plant growth regulator active compounds.

In addition to these additional active agents, the pesticide composition according to the invention may also comprise any other adjuvants or auxiliary agent useful in plant protection formulations such as, for example, an agriculturally suitable inert carrier and optionally an agriculturally suitable surfactant.

For its practical use, the pesticide composition according to the invention can be used alone or in formulations containing one or the other of the active ingredients or alternatively both of them together, in combination or association with one or more other compatible components which are, for example, solid or liquid fillers or diluents, adjuvants, surfactants or equivalents, which are suitable for the desired use and which are acceptable for uses in agriculture. The formulations can be of any type known in the sector that is suitable for application onto all types of cultures or crops. These formulations, which can be prepared in any manner known by the skilled person, also form part of the invention.

The formulations may also contain ingredients of other types, such as protective colloids, adhesives, thickeners, thixotropic agents, penetrating agents, oils for spraying, stabilisers, preserving agents (in particular mould-proofing or biocide agents), sequestering or chelating agents or the like. More generally, the compounds used in the invention can be combined with any solid or liquid additives corresponding to the usual formulation techniques.

The term “filler” means an organic or inorganic, natural or synthetic component with which the active components are combined to facilitate its application, for example, onto the plants, the seeds or the soil. This filler is consequently generally inert and it must be acceptable (for example acceptable for agronomic uses, in particular for treating plants).

The filler can be solid, for example clays, natural or synthetic silicates, silica, resins, waxes, solid fertilizers (for example ammonium salts), natural soil minerals, such as kaolins, clays, talc, lime, quartz, attapulgite, montmorillonite, bentonite or diatomaceous earths or synthetic minerals, such as silica, alumina or silicates, in particular aluminium or magnesium silicates. The solid fillers which are suitable for granules are as follows: natural, crushed or broken rocks, such as calcite, marble, pumice, sepiolite and dolomite; synthetic granules of inorganic or organic flours; granules of organic material such as sawdust, coconut shell, corn ear or envelope or tobacco stem; kieselguhr, tricalcium phosphate, powdered cork or adsorbent carbon black; water-soluble polymers, resins, waxes; or solid fertilizers. Such composition may, if so desired, contain one or more compatible agents such as wetting agents, dispersing agents, emulsifiers or colourings which, when they are solid, may also act as diluents.

The fillers may also be liquid, for example: water, alcohols, in particular butanol or glycol, as well as ethers or esters thereof, in particular methyl glycol acetate; ketones, in particular acetone, cyclohexanone, methyl ethyl ketone, methyl isobutyl ketone or isophorone; petroleum fractions such as paraffinic or aromatic hydrocarbons, in particular xylenes or alkylnaphthalenes; mineral or plant oils; aliphatic chlorohydrocarbons, in particular trichloroethane or methylene chloride; aromatic chlorohydrocarbons, in particular chlorobenzenes; water-soluble or highly polar solvents such as dimethylformamide, dimethyl sulphoxide, N,N-dimethyl-acetamide or N-methylpyrrolidone; N-octylpyrrolidone, liquefied gases; or the like, whether they are taken separately or as a mixture.

The surfactant can be an emulsifier, a dispersing agent or a wetting agent, of ionic or nonionic type or a mixture of these surfactants. Among those surfactants there are used, for example, polyacrylic acid salts, lignosulphonic acid salts, phenolsulphonic or naphthalenesulphonic acid salts, polycondensates of ethylene oxide with fatty alcohols or fatty acids or fatty esters or fatty amines, substituted phenols (in particular alkylphenols or arylphenols), ester-salts of sulphosuccinic acid, taurine derivatives (in particular alkyl taurates), phosphoric esters of alcohols or of polycondensates of ethylene oxide with phenols, fatty acid esters with polyols or sulphate, sulphonate or phosphate functional derivatives of the compounds described above. The presence of at least one surfactant is generally essential when the active ingredients and/or the inert filler are insoluble or only sparingly soluble in water and when the filler for the said composition to be applied is water.

The formulations may also contain other additives such as adhesives or dyes. Adhesives such as carboxymethylcellulose or natural or synthetic polymers in the form of powders, granules or matrices, such as gum arabic, latex, polyvinylpyrrolidone, polyvinyl alcohol or polyvinyl acetate, natural phospholipids, such as cephalins or lecithins or synthetic phospholipids can be used in the formulations. It is possible to use colourings such as inorganic pigments, such as, for example: iron oxides, titanium oxides, Prussian blue; organic colouring stuffs, such as those of the alizarin, azo or metal phthalocyanin type; or of trace elements such as iron, manganese, boron, copper, cobalt, molybdenum or zinc salts.

The form of the pesticide composition according to the invention can be selected in a large number of formulations, such as aerosol dispenser; suspension of capsules; cold fogging concentrate; dustable powder; emulsifiable concentrate; aqueous/aqueous type emulsion; oil/inverse type emulsion; encapsulated granule; fine granule; suspension concentrate for seed treatment; compressed gas; gas generating product; granule; hot fogging concentrate; macrogranule; microgranule; oil-dispersible powder; oil miscible suspension concentrate; oil-miscible liquid; paste; plant rodlet; powder for dry seed treatment; seeds coated with a pesticide; smoke maydle; smoke cartridge; smoke generator; smoke pellet; smoke rodlet; smoke tablet; smoke tin; soluble concentrate; soluble powder; solution for seed treatment; suspension concentrate (=flowable concentrate); ultra low volume liquid; ultra low volume suspension; vapour releasing product; water-dispersible granules or tablets; water dispersible powder for slurry treatment; water-soluble granules or tablets; water-soluble powder for seed treatment; wettable powder.

The pesticide composition according to the present invention covers not only the compositions which are ready to be applied to the crop by means of a suitable device, such as a spraying device, but also the commercial concentrated composition which have to be diluted before application to the crop.

The pesticide composition herein described is used in general for application to growing plants or to sites where crops are grown or intended to grow or for the treatment, coating or film-coating of seeds.

According to the present invention, seeds may comprise any propagation materials, like for example seeds, fruit, tubers, grains, roots, rhizomes, parts of plants.

The pesticide composition according to the invention may also be applied to the vegetation and in particular to the leaves infested or capable of being infested with the phytopathogenic fungi or damaged by insects. Another method of applying the pesticide composition according to the invention is to add a formulation containing the active ingredients to the irrigation water.

According to another object of the present invention, there is provided a method for controlling the phytopathogenic fungi or damaging insects of plants, crops or seeds, characterized in that an agronomically effective and substantially non-phytotoxic quantity of a pesticide composition according to the invention is applied as seed treatment, foliar application, stem application, drench or drip application (chemigation) to the seed, the plant or to the fruit of the plant or to soil or to inert substrate (e.g. inorganic substrates like sand, rockwool, glasswool; expanded minerals like perlite, vermiculite, zeolite or expanded clay), Pumice, Pyroclastic materials or stuff, synthetic organic substrates (e.g. polyurethane) organic substrates (e.g. peat, composts, tree waste products like coir, wood fibre or chips, tree bark) or to a liquid substrate (e.g. floating hydroponic systems, Nutrient Film Technique, Aeroponics) wherein the plant is growing or wherein it is desired to grow.

The expression “are applied to the plants to be treated” is understood to mean, for the purposes of the present invention, that the pesticide composition which is the subject of the invention can be applied by means of various methods of treatment such as:
spraying onto the aerial parts of the said plants a liquid comprising one of the said compositions,
dusting, the incorporation into the soil of granules or powders, spraying, around the said plants, and in the case of trees injection or daubing,
coating or film-coating the seeds of the said plants with the aid of a plant-protection mixture comprising one of the said compositions.

The method according to the invention may either be a curing, preventing or eradicating method.

In this method, a composition used can be prepared beforehand by mixing the two or more active compounds according to the invention.

According to an alternative of such a method, it is also possible to apply simultaneously, successively or separately compounds (A), (B), (C) or (D) so as to have the conjugated (A)/(B)/(C)/(D) effects, of distinct compositions each containing one or more active ingredients (A), (B), (C) or (D).

The dose of active compound usually applied in the method of treatment according to the invention is generally and advantageously
for foliar treatments: from 0.1 to 10,000 g/ha, preferably from 10 to 1,000 g/ha, more preferably from 50 to 300 g/ha; in case of drench or drip application, the dose can even be reduced, especially while using inert substrates like rockwool or perlite;
for seed treatment: from 2 to 200 g per 100 kilogram of seed, preferably from 3 to 150 g per 100 kilogram of seed;
for soil treatment: from 0.1 to 10,000 g/ha, preferably from 1 to 5,000 g/ha.

The doses herein indicated are given as illustrative Examples of method according to the invention. A person skilled in the art will know how to adapt the application doses, notably according to the nature of the plant or crop to be treated.

Under specific conditions, for example according to the nature of the phytopathogenic fungus to be treated or insect to control, a lower dose may offer adequate protection. Certain climatic conditions, resistance or other factors like the nature of the phytopathogenic fungi or damaging insect to be eliminated or the degree of infestation, for example, of the plants with these fungi, may require higher doses of combined active ingredients.

The optimum dose usually depends on several factors, for example on the type of phytopathogenic fungus to be treated or insect to control, on the type or level of development of the infested plant, on the density of vegetation or alternatively on the method of application.

Without it being limiting, the crop treated with the pesticide composition or combination according to the invention is, for example, grapevine, but this could be cereals, vegetables, lucerne, soybean, market garden crops, turf, wood, tree or horticultural plants.

The method of treatment according to the invention may also be useful to treat propagation material such as tubers or rhizomes, but also seeds, seedlings or seedlings pricking out and plants or plants pricking out. This method of treatment may also be useful to treat roots. The method of treatment according to the invention may also be useful to treat the over-ground parts of the plant such as trunks, stems or stalks, leaves, flowers and fruit of the concerned plant.

Among the plants that may be can be protected by the method according to the invention, mention may be can be made of cotton; flax; vine; fruit or vegetable crops such as Rosaceae sp. (for instance pip fruit such as apples and pears, but also stone fruit such as apricots, almonds and peaches), Ribesioidae sp., Juglandaceae sp., Betulaceae sp., Anacardiaceae sp., Fagaceae sp., Moraceae sp., Oleaceae sp., Actimidaceae sp., Lauraceae sp., Musaceae sp. (for instance banana trees and plantins), Rubiaceae sp., Theaceae sp., Sterculiceae sp., Rutaceae sp. (for instance lemons oranges and grapefruit); Solanaceae sp. (for instance tomatoes), Liliaceae sp., Asteraceae sp. (for instance lettuces), Umbelliferae sp., Cruciferae sp., Chenopodiaceae sp., Cucurbitaceae sp., Papilionaceae sp. (for instance peas), Rosaceae sp. (for instance strawberries); major crops such as Graminae sp. (for instance maize, lawn or cereals such as wheat, rye, rice, barley and triticale), Asteraceae sp. (for instance sunflower), Cruciferae sp. (for instance colza), Fabacae sp. (for instance peanuts), Papilionaceae sp. (for instance soybean), Solanaceae sp. (for instance potatoes), Chenopodiaceae sp. (for instance beetroots), Elaeis sp. (for instance oil palm); horticultural and forest crops; as well as genetically modified homologues of these crops.

The composition according to the invention may also be used in the treatment of genetically modified organisms with the compounds according to the invention or the agrochemical compositions according to the invention. Genetically modified plants are plants into genome of which a heterologous gene encoding a protein of interest has been stably integrated. The expression “heterologous gene encoding a protein of interest” essentially means genes which give the transformed plant new agronomic properties or genes for improving the agronomic to quality of the modified plant.

The composition according to the invention may also be used against fungal diseases liable to grow on or inside timber. The term “timber” means all types of species of wood, and all types of working of this wood intended for construction, for example solid wood, high-density wood, laminated wood, and plywood. The method for treating timber according to the invention mainly consists in contacting one or more compounds according to the invention or a composition according to the invention; this includes for example direct application, spraying, dipping, injection or any other suitable means.

Among the diseases of plants or crops that can be controlled by the method according to the invention, mention can be made of:

Powdery Mildew Diseases such as
Blumeria diseases caused for example by Blumeria graminis;
Podosphaera diseases caused for example by Podosphaera leucotricha;
Sphaerotheca diseases caused for example by Sphaerotheca fuliginea;
Uncinula diseases caused for example by Uncinula necator;
Rust Diseases such as
Gymnosporangium diseases caused for example by Gymnosporangium sabinae;
Hemileia diseases caused for example by Hemileia vastatrix;
Phakopsora diseases caused for example by Phakopsora pachyrhizi and Phakopsora meibomiae;
Puccinia diseases caused for example by Puccinia recondita, Puccinia graminis or Puccinia striiformis;
Uromyces diseases caused for example by Uromyces appendiculatus;
Oomycete Diseases such as
Albugo diseases caused for example by Albugo candida;
Bremia diseases caused for example by Bremia lactucae;
Peronospora diseases caused for example by Peronospora pisi and Peronospora brassicae;
Phytophthora diseases caused for example by Phytophthora infestans;
Plasmopara diseases caused for example by Plasmopara viticola;
Pseudoperonospora diseases caused for example by Pseudoperonospora humuli and Pseudo-peronospora cubensis;
Pythium diseases caused for example by Pythium ultimum;
Leaf spot, Leaf blotch and Leaf Blight Diseases such as
Alternaria diseases caused for example by Alternaria solani;
Cercospora diseases caused for example by Cercospora beticola;
Cladiosporium diseases caused for example by Cladiosporium cucumerinum;
Cochliobolus diseases caused for example by Cochliobolus sativus (Conidiaform: Drechslera, Syn: Helminthosporium) or Cochliobolus miyabeanus;
Colletotrichum diseases caused for example by Colletotrichum lindemuthianum;
Cycloconium diseases caused for example by Cycloconium oleaginum;
Diaporthe diseases caused for example by Diaporthe citri;
Elsinoe diseases caused for example by Elsinoe fawcettii;
Gloeosporium diseases caused for example by Gloeosporium laeticolor;
Glomerella diseases caused for example by Glomerella cingulata;
Guignardia diseases caused for example by Guignardia bidwellii;
Leptosphaeria diseases caused for example by Leptosphaeria maculans and Leptosphaeria nodorum;
Magnaporthe diseases caused for example by Magnaporthe grisea;
Mycosphaerella diseases caused for example by Mycosphaerella graminicola, Mycosphaerella arachidicola and Mycosphaerella fijiensis;
Phaeosphaeria diseases caused for example by Phaeosphaeria nodorum;
Pyrenophora diseases caused for example by Pyrenophora teres or Pyrenophora tritici repentis;
Ramularia-diseases caused for example by Ramularia collo-cygni or Ramularia areola;
Rhynchosporium diseases caused for example by Rhynchosporium secalis;
Septoria diseases caused for example by Septoria apii and Septoria lycopersici;
Typhula diseases caused for example by Thyphula incarnata;
Venturia diseases caused for example by Venturia inaequalis;
Root-, Sheath and Stem Diseases such as
   Corticium diseases caused for example by Corticium graminearum;
   Fusarium diseases caused for example by Fusarium oxysporum;
   Gaeumannomyces diseases caused for example by Gaeumannomyces graminis;
   Rhizoctonia diseases caused for example by Rhizoctonia solani;
   Sarocladium diseases caused for example by Sarocladium oryzae;
   Sclerotium diseases caused for example by Sclerotium oryzae;
   Tapesia diseases caused for example by Tapesia acuformis;
   Thielaviopsis diseases caused for example by Thielaviopsis basicola;
   Ear and Panicle Diseases including Maize cob such as
   Alternaria diseases caused for example by Alternaria spp.;
   Aspergillus diseases caused for example by Aspergillus flavus;
   Cladosporium diseases caused for example by Cladosporium cladosporioides;
   Claviceps diseases caused for example by Claviceps purpurea;
   Fusarium diseases caused for example by Fusarium culmorum;
   Gibberella diseases caused for example by Gibberella zeae;
   Monographella diseases caused for example by Monographella nivalis;
Smut- and Bunt Diseases such as
   Sphacelotheca diseases caused for example by Sphacelotheca reiliana;
   Tilletia diseases caused for example by Tilletia caries;
   Urocystis diseases caused for example by Urocystis occulta;
   Ustilago diseases caused for example by Ustilago nuda;
   Fruit Rot and Mould Diseases such as
   Aspergillus diseases caused for example by Aspergillus flavus;
   Botrytis diseases caused for example by Botrytis cinerea;
   Penicillium diseases caused for example by Penicillium expansum and Penicillium purpurogenum;
   Rhizopus diseases caused by example by Rhizopus stolonifer
   Sclerotinia diseases caused for example by Sclerotinia sclerotiorum;
   Verticillium diseases caused for example by Verticillium alboatrum;
   Seed- and Soilborne Decay, Mould, Wilt, Rot and Damping-off diseases
   Alternaria diseases caused for example by Alternaria brassicicola;
   Aphanomyces diseases caused for example by Aphanomyces euteiches;
   Ascochyta diseases caused for example by Ascochyta lentis;
   Aspergillus diseases caused for example by Aspergillus flavus;
   Cladosporium diseases caused for example by Cladosporium herbarum;
   Cochliobolus diseases caused for example by Cochliobolus sativus;

### (Conidiaform: Drechslera, Bipolaris Syn: Helminthosporium);

Colletotrichum diseases caused for example by Colletotrichum coccodes;
Fusarium diseases caused for example by Fusarium culmorum;
Gibberella diseases caused for example by Gibberella zeae;
Macrophomina diseases caused for example by Macrophomina phaseolina;
Microdochium diseases caused for example by Microdochium nivale;
Monographella diseases caused for example by Monographella nivalis;
Penicillium diseases caused for example by Penicillium expansum;
Phoma diseases caused for example by Phoma lingam;
Phomopsis diseases caused for example by Phomopsis sojae;
Phytophthora diseases caused for example by Phytophthora cactorum;
Pyrenophora diseases caused for example by Pyrenophora graminea;
Pyricularia diseases caused for example by Pyricularia oryzae;
Pythium diseases caused for example by Pythium ultimum;
Rhizoctonia diseases caused for example by Rhizoctonia solani;
Rhizopus diseases caused for example by Rhizopus oryzae;
Sclerotium diseases caused for example by Sclerotium rolfsii;
Septoria diseases caused for example by Septoria nodorum;
Typhula diseases caused for example by Typhula incarnata;
Verticillium diseases caused for example by Verticillium dahliae;
Canker, Broom and Dieback Diseases such as
Nectria diseases caused for example by Nectria galligena;
Blight Diseases such as
Monilinia diseases caused for example by Monilinia laxa;
Leaf Blister or Leaf Curl Diseases including deformation of blooms and fruits such as
Exobasidium diseases caused for example by Exobasidium vexans.
Taphrina diseases caused for example by Taphrina deformans;
Decline Diseases of Wooden Plants such as
Esca disease caused for example by Phaeomoniella clamydospora, Phaeoacremonium aleophilum and Fomitiporia mediterranea;
Ganoderma diseases caused for example by Ganoderma boninense;
Rigidoporus diseases caused for example by Rigidoporus lignosus
Diseases of Flowers and Seeds such as
Botrytis diseases caused for example by Botrytis cinerea;
Diseases of Tubers such as
Rhizoctonia diseases caused for example by Rhizoctonia solani;
Helminthosporium diseases caused for example by Helminthosporium solani;
Club root diseases such as
Plasmodiophora diseases, cause for example by Plamodiophora brassicae.
Diseases caused by Bacterial Organisms such as
Xanthomonas species for example Xanthomonas campestris pv. oryzae;
Pseudomonas species for example Pseudomonas syringae pv. lachrymans;
Erwinia species for example Erwinia amylovora.

The damaging insects of crops which can be controlled at any development stage by using the pesticide composition according to the invention include:
pests from the order of Isopoda for example Oniscus asellus, Armadillidium vulgare, Porcellio scaber;
pests from the order of Diplopoda for example Blaniulus guttulatus;
pests from the order of Chilopoda for example Geophilus carpophagus, Scutigera spp.;
pests from the order of Symphyla for example Scutigerella immaculata;
pests from the order of Thysanura for example Lepisma saccharina;
pests from the order of Collembola for example Onychiurus armatus;
pests from the order of Orthoptera for example Acheta domesticus, Gryllotalpa spp., Locusta migratoria migratorioides, Melanoplus spp., Schistocerca gregaria;
pests from the order of Blattaria for example Blatta orientalis, Periplaneta americana, Leucophaea maderae, Blattella germanica;
pests from the order of Dermaptera for example Forficula auricularia;
pests from the order of Isoptera for example Reticulitermes spp.;
pests from the order of Phthiraptera for example Pediculus humanus corporis, Haematopinus spp., Linognathus spp., Trichodectes spp., Damalinia spp.;
pests from the order of Thysanoptera for example Hercinothrips femoralis, Thrips tabaci, Thrips palmi, Frankliniella accidentalis;
pests from the order of Heteroptera for example Eurygaster spp., Dysdercus intermedius, Piesma quadrata, Cimex lectularius, Rhodnius prolixus, Triatoma spp;
pests from the order of Homoptera for example Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium comi, Saissetia oleae, Laodelphax striatellus, Nilaparvata lugens, Aonidiella aurantii, Aspidiotus hederae, Pseudococcus spp., Psylla spp;
pests from the order of Lepidoptera for example Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae;
pests from the order of Coleoptera for example Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp. oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus;
pests from the order of Hymenoptera for example Diprion spp., Hoplocampa spp., Lasius spp., Monomorium pharaonis, Vespa spp;
pests from the order of Diptera for example Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp.;
pests from the order of Siphonaptera for example Xenopsylla cheopis, Ceratophyllus spp.;
pests from the class of Arachnida for example Scorpio maurus, Latrodectus mactans, Acarus siro, Argas spp. ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp;
the plant-parasitic nematodes such as Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., Bursaphelenchus spp.

As a further aspect, the present invention provides a product comprising compounds (A), (B), (C) and (D) as herein defined, as a combined preparation for simultaneous, separate or sequential use in controlling the phytopathogenic fungi or damaging insects of plants, crops or seeds at a site.

The pesticide composition according to the invention can be prepared immediately before use by using a kit-of-parts for controlling, curatively or preventively, the phytopathogenic fungi of crops, such a kit-of-parts may comprise at least one or several compounds (A), (B), (C) and (D) intended to be combined or used simultaneously, separately or sequentially in controlling the phytopathogenic fungi of crops at a site.

It is therefore a pack wherein the user finds all the ingredients for preparing the fungicide formulation which they wish to apply to the crops. These ingredients, which comprise in particular the active agents (A), (B), (C) and (D) and which are packaged separately, are provided in the form of a powder or in the form of a liquid which is concentrated to a greater or lesser degree. The user simply has to mix in the prescribed doses and to add the quantities of liquid, for example of water, necessary to obtain a formulation which is ready to use and which can be applied to the crops.

The good fungicidal activity of the active compound combinations according to the invention is evident from the example below. While the individual active compounds exhibit weaknesses with regard to the fungicidal activity, the combinations have an activity which exceeds a simple addition of activities.

A synergistic effect of fungicides is always present when the fungicidal activity of the active compound combinations exceeds the total of the activities of the active compounds when applied individually.

The expected activity for a given combination of two active compounds can be calculated as follows (cf. Colby, S. R., “Calculating Synergistic and Antagonistic Responses of Herbicide Combinations”, Weeds 15, pages 20-22, 1967):

If

X is the efficacy, when applying the active compound A at a rate of application of active compound of m ppm,
Y is the efficacy, when applying the active compound B at a rate of application of active compound of n ppm,
E is the expected efficacy, when applying the active compounds A and B at rates of application of active compound of m and n ppm,
then

$$E = X + Y - \frac{X \cdot Y}{100}$$

The degree of efficacy, expressed in % is denoted. 0% means an efficacy which corresponds to that of the control while an efficacy of 100% means that no disease is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

The invention is illustrated by the following examples.

### EXAMPLE

### Phytophthora Test (Tomatoes)/Protective

Solvent: 24.5 parts by weight of acetone
24.5 parts by weight of dimethylacetamide
   Emulsifier: 1 part by weight of alkylaryl polyglycol ether

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated rate of application. After the spray coating has dried on, the plants are inoculated with an aqueous spore suspension of Phytophthora infestans. The plants are then placed in an incubation cabinet at approximately 20° C. and a relative atmospheric humidity of 100%.

The test is evaluated 3 days after the inoculation. 0% means an efficacy which corresponds to that of the control, while an efficacy of 100% means that no disease is observed.

The table below clearly shows that the observed activity of the active compound combination according to the invention is greater than the calculated activity, i.e. a synergistic effect is present.

### Phytophthora Test (Tomatoes)/Protective

| | | Application rate of | | |
|---|---|---|---|---|
| | | active compound in | Efficacy in % | |
| Active compounds | | ppm a.i. | found* | calc.** |
| Ex. A | 6-[({[(1-methyl-1H-tetrazol-5- | | 69 | |
| | yl)(phenyl)methylene]amino}oxy) | | | |
| | methyl]-N-pentylpyridin-2-amine | | | |
| Ex. B10 | benthiavalicarb | 0.25 | 16 | |
| Ex. B14 | fluopicolide | 0.25 | 4 | |
| Ex. B2 | zoxamide | 0.25 | 18 | |
| Ex. B10 | dimethomorph | 0.5 | 35 | |
| A + B10 | benthiavalicarb 1:1 | 0.25 + 0.25 | 84 | 74 |
| A + B14 | fluopicolide 1:1 | 0.25 + 0.25 | 81 | 70 |
| A + B2 | zoxamide 1:1 | 0.25 + 0.25 | 89 | 75 |
| A + B10 | dimethomorph 1:2 | 0.25 + 0.5 | 89 | 80 |

*found = activity found
**calc. = activity calculated using Colby's formula

### Phytophthora Test (Tomatoes)/Protective

| | | Application rate of | | |
|---|---|---|---|---|
| | | active compound in | Efficacy in % | |
| Active compounds | | ppm a.i. | found* | calc.** |
| Ex. A | N-hexyl-6-[({[(1-methyl-1H-tetrazol- | 0.25 | 48 | |
| | 5-yl)(phenyl)methylene]amino}oxy)- | 0.5 | 63 | |
| | methyl]pyridin-2-amine | | | |
| Ex. B13 | chlorothalonil | 12.5 | 19 | |
| Ex. B13 | copper oxychloride | 12.5 | 58 | |
| Ex. B14 | fosetyl-aluminium | 12.5 | 42 | |
| Ex. B14 | phosporous acid | 12.5 | 33 | |
| Ex. B8 | propamocarb-HCl | 25 | 24 | |
| A + B13 | chlorothalonil 1:50 | 0.25 + 12.5 | 76 | 58 |
| A + B13 | copper oxychl. 1:50 | 0.25 + 12.5 | 82 | 78 |
| A + B14 | fosetyl-aluminium 1:50 | 0.25 + 12.5 | 90 | 70 |
| A + B14 | phosporous acid 1:50 | 0.25 + 12.5 | 93 | 65 |
| A + B8 | propamocarb-HCl 1:50 | 0.5 + 25 | 92 | 72 |

*found = activity found
**calc. = activity calculated using Colby's formula

1. A composition comprising:
A) a tetrazolyloxime derivative of formula (I) 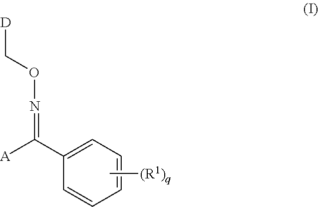
wherein
R¹ represents a hydrogen atom, a halogen atom, a substituted or non-substituted C₁-C₆-alkyl, a substituted or non-substituted C₁-C₆-alkoxy, nitro, cyano, a substituted or non-substituted C₁-C₆-aryl or a substituted or non-substituted C₁-C₆-alkylsulphonyl;
q represents 0, 1, 2, 3, 4 or 5;
A represents a tetrazoyl group of formula (A¹) or (A²): 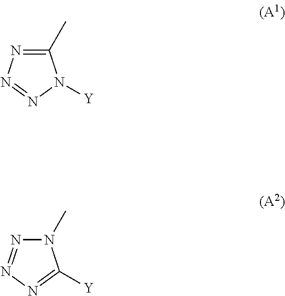
wherein Y represents an C₁-C₆-alkyl group; and
D represents a pyridyl group of formula (D¹) or a thiazolyl group of formula (D²); 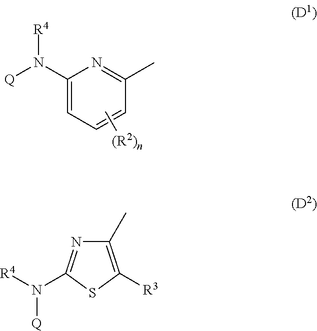
wherein R² and R³ independently represent a hydrogen atom, a halogen atom, a substituted or non-substituted C₁-C₆-alkyl, a substituted or non-substituted C₁-C₆-alkoxy, substituted or non-substituted C₁-C₆-alkylthio, substituted or non-substituted amino, a substituted or non-substituted C₁-C₆-aryl;
n represents 0, 1, 2 or 3;
R⁴ represents a hydrogen atom, a formyl, a substituted or non-substituted C₁-C₆-alkylcarbonyl, a substituted or non-substituted C₁-C₆-haloalkylalkylcarbonyl comprising between one and 9 halogen atoms, a substituted or non-substituted C₁-C₆-alkoxycarbonyl;
Q represents a substituted or non-substituted C₁-C₂₀-alkyl, a substituted or non-substituted C₂-C₂₀-alkenyl, a substituted or non-substituted C₂-C₂₀-alkynyl, a substituted or non-substituted C₃-C₈-cycloalkyl, substituted or non-substituted aryl-[C₁-C₈]-alkyl, substituted or non-substituted, saturated or unsaturated 4-, 5-, 6- or 7-membered heterocyclyl-[C₁-C₈]-alkyl comprising up to 4 heteroatoms selected in the list consisting of N, O, S;
as well as salts, N-oxides, metallic complexes and metalloidic complexes thereof or (E) and (Z) isomers and mixtures thereof
and
B) a fungicide compound in an A/B weight ratio ranging from 0.001/1 to 1/1,000.

2. A composition comprising:
A) a tetrazolyloxime derivative of formula (I) 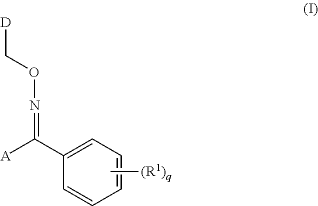
wherein
R¹ represents a hydrogen atom, a halogen atom, a substituted or non-substituted C₁-C₆-alkyl, a substituted or non-substituted C₁-C₆-alkoxy, nitro, cyano, a substituted or non-substituted C₁-C₆-aryl or a substituted or non-substituted C₁-C₆-alkylsulphonyl;
q represents 0, 1, 2, 3, 4 or 5;
A represents a tetrazoyl group of formula (A¹) or (A²): 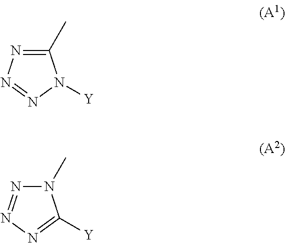
wherein Y represents an C₁-C₆-alkyl group; and
D represents a pyridyl group of formula (D¹) or a thiazolyl group of formula (D²); 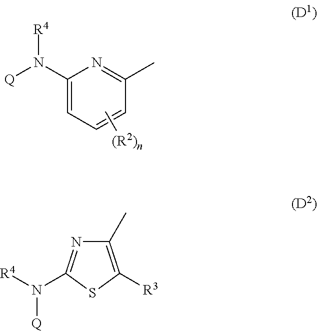
wherein R² and R³ independently represent a hydrogen atom, a halogen atom, a substituted or non-substituted C₁-C₆-alkyl, a substituted or non-substituted C₁-C₆-alkoxy, substituted or non-substituted C₁-C₆-alkylthio, substituted or non-substituted amino, a substituted or non-substituted C₁-C₆-aryl;
n represents 0, 1, 2 or 3;
R⁴ represents a hydrogen atom, a formyl, a substituted or non-substituted C₁-C₆-alkylcarbonyl, a substituted or non-substituted C₁-C₆-haloalkylalkylcarbonyl comprising between one and 9 halogen atoms, a substituted or non-substituted C₁-C₆-alkoxycarbonyl;
Q represents a substituted or non-substituted C₁-C₂₀-alkyl, a substituted or non-substituted C₂-C₂₀-alkenyl, a substituted or non-substituted C₂-C₂₀-alkynyl, a substituted or non-substituted C₁-C₈-cycloalkyl, substituted or non-substituted aryl-[C₁-C₈]-alkyl, substituted or non-substituted, saturated or unsaturated 4-, 5-, 6- or 7-membered heterocyclyl-[C₁-C₈]-alkyl comprising up to 4 heteroatoms selected in the list consisting of N, O, S;
as well as salts, N-oxides, metallic complexes and metalloidic complexes thereof or (E) and (Z) isomers and mixtures thereof;
B) a fungicide compound; and
C) a second further fungicide compound in an A/B/C weight ratio ranging from 0.001/0.001/1 to 1/1,000/1,000.

3. A composition comprising:
A) a tetrazolyloxime derivative of formula (I) 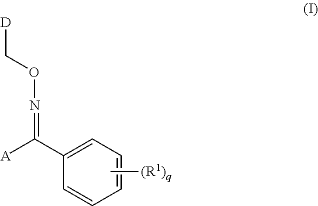
wherein
R¹ represents a hydrogen atom, a halogen atom, a substituted or non-substituted C₁-C₆-alkyl, a substituted or non-substituted C₁-C₆-alkoxy, nitro, cyano, a substituted or non-substituted C₁-C₆-aryl or a substituted or non-substituted C₁-C₆-alkylsulphonyl;
q represents 0, 1, 2, 3, 4 or 5;
A represents a tetrazoyl group of formula (A¹) or (A²): 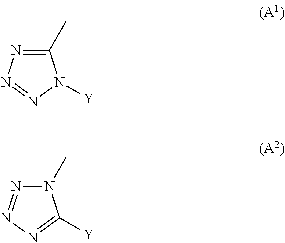
wherein Y represents an C₁-C₆-alkyl group; and
D represents a pyridyl group of formula (D¹) or a thiazolyl group of formula (D²); 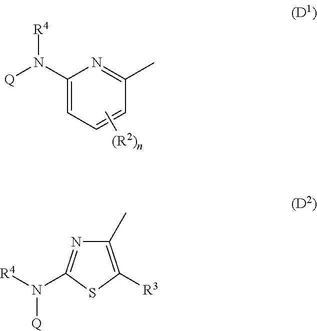
wherein R² and R³ independently represent a hydrogen atom, a halogen atom, a substituted or non-substituted C₁-C₆-alkyl, a substituted or non-substituted C₁-C₆-alkoxy, substituted or non-substituted C₁-C₆-alkylthio, substituted or non-substituted amino, a substituted or non-substituted C₁-C₆-aryl;
n represents 0, 1, 2 or 3;
R⁴ represents a hydrogen atom, a formyl, a substituted or non-substituted C₁-C₆-alkylcarbonyl, a substituted or non-substituted C₁-C₆-haloalkylalkylcarbonyl comprising between one and 9 halogen atoms, a substituted or non-substituted C₁-C₆-alkoxycarbonyl;
Q represents a substituted or non-substituted C₁-C₂₀-alkyl, a substituted or non-substituted C₂-C₂₀-alkenyl, a substituted or non-substituted C₂-C₂₀-alkenyl, a substituted or non-substituted C₃-C₈-cycloalkyl, substituted or non-substituted aryl-[C₁-C₈]-alkyl, substituted or non-substituted, saturated or unsaturated 4-, 5-, 6- or 7-membered heterocyclyl-[C₁-C₈]-alkyl comprising up to 4 heteroatoms selected in the list consisting of N, O, S;
as well as salts, N-oxides, metallic complexes and metalloidic complexes thereof or (E) and (Z) isomers and mixtures thereof;
B) a fungicide compound; and
D) an insecticide compound in an A/B/D weight ratio ranging from 0.001/0.001/1 to 1/1,000/1,000.

4. A composition comprising:
A) a tetrazolyloxime derivative of formula (I) 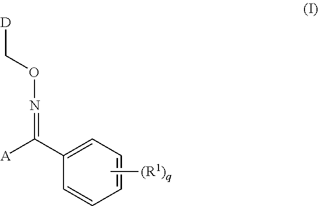
wherein
R¹ represents a hydrogen atom, a halogen atom, a substituted or non-substituted C₁-C₆-alkyl, a substituted or non-substituted C₁-C₆-alkoxy, nitro, cyano, a substituted or non-substituted C₁-C₆-aryl or a substituted or non-substituted C₁-C₆-alkylsulphonyl;
q represents 0, 1, 2, 3, 4 or 5;
A represents a tetrazoyl group of formula (A¹) or (A²): 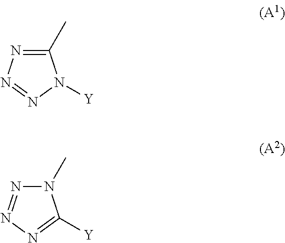
wherein Y represents an C₁-C₆-alkyl group; and
D represents a pyridyl group of formula (D¹) or a thiazolyl group of formula (D²); 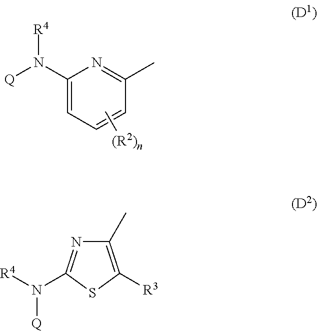
wherein R² and R³ independently represent a hydrogen atom, a halogen atom, a substituted or non-substituted C₁-C₆-alkyl, a substituted or non-substituted C₁-C₆-alkoxy, substituted or non-substituted C₁-C₆-alkylthio, substituted or non-substituted amino, a substituted or non-substituted C₁-C₆-aryl;
n represents 0, 1, 2 or 3;
R⁴ represents a hydrogen atom, a formyl, a substituted or non-substituted C₁-C₆-alkylcarbonyl, a substituted or non-substituted C₁-C₆-haloalkylalkylcarbonyl comprising between one and 9 halogen atoms, a substituted or non-substituted C₁-C₆-alkoxycarbonyl;
Q represents a substituted or non-substituted C₁-C₂₀-alkyl, a substituted or non-substituted C₂-C₂₀-alkenyl, a substituted or non-substituted C₁-C₂₀-alkynyl, a substituted or non-substituted C₃-C₈-cycloalkyl, substituted or non-substituted aryl-[C₁-C₈]-alkyl, substituted or non-substituted, saturated or unsaturated 4-, 5-, 6- or 7-membered heterocyclyl-[C₁-C₈]-alkyl comprising up to 4 heteroatoms selected in the list consisting of N, O, S;
as well as salts, N-oxides, metallic complexes and metalloidic complexes thereof or (E) and (Z) isomers and mixtures thereof;
and
D) an insecticide compound in an A/D weight ratio ranging from 1/1,000 to 1,000/1.

5. A composition comprising:
A) a tetrazolyloxime derivative of formula (I); 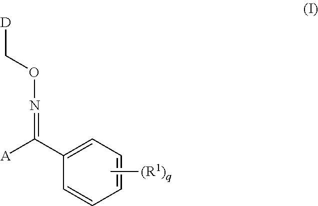
wherein
R¹ represents a hydrogen atom, a halogen atom, a substituted or non-substituted C₁-C₆-alkyl, a substituted or non-substituted C₁-C₆-alkoxy, nitro, cyano, a substituted or non-substituted C₁-C₆-aryl or a substituted or non-substituted C₁-C₆-alkylsulphonyl;
q represents 0, 1, 2, 3, 4 or 5-,
A represents a tetrazoyl group of formula (A¹) or (A²): 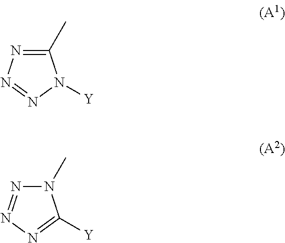
wherein Y represents an C₁-C₆-alkyl group; and
D represents a pyridyl group of formula (D¹) or a thiazolyl group of formula (D²); 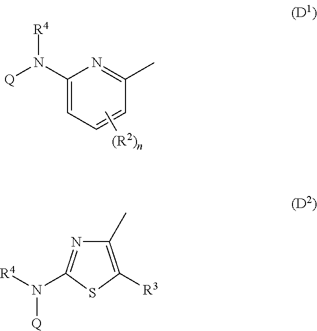
wherein R² and R³ independently represent a hydrogen atom, a halogen atom, a substituted or non-substituted C₁-C₆-alkyl, a substituted or non-substituted C₁-C₆-alkoxy, substituted or non-substituted C₁-C₆-alkylthio, substituted or non-substituted amino, a substituted or non-substituted C₁-C₆-aryl;
n represents 0, 1, 2 or 3;
R⁴ represents a hydrogen atom, a formyl, a substituted or non-substituted C₁-C₆-alkylcarbonyl, a substituted or non-substituted C₁-C₆-haloalkylalkylcarbonyl comprising between one and 9 halogen atoms, a substituted or non-substituted C₁-C₆-alkoxycarbonyl;
Q represents a substituted or non-substituted C₁-C₂₀-alkyl, a substituted or non-substituted C₂-C₂₀-alkenyl, a substituted or non-substituted C₂-C₂₀-alkynyl, a substituted or non-substituted C₁-C₈-cycloalkyl, substituted or non-substituted aryl-[C₁-C₈]-alkyl, substituted or non-substituted, saturated or unsaturated 4-, 5-, 6- or 7-membered heterocyclyl-[C₁-C₈]-alkyl comprising up to 4 heteroatoms selected in the list consisting of N, O, S;
as well as salts, N-oxides, metallic complexes and metalloidic complexes thereof or (E) and (Z) isomers and mixtures thereof;
B) a fungicide compound;
C) a second further fungicide compound; and
D) an insecticide compound in an A/B/C/D weight ratio ranging from 0.001/0.001/0.001/1 to 1/1,000/1,000/1,000.

6. A composition according to claim 1 wherein the substitution position of R¹ in the tetrazolyloxime derivative of formula (I) is not specifically limited and R¹ represents a hydrogen atom, a halogen atom, a substituted or non-substituted C₁-C₆-alkyl, a substituted or non-substituted C₁-C₆-alkoxy.

7. A composition according to claim 1 wherein the substitution position of R¹ in the tetrazolyloxime derivative of formula (I) is not specifically limited and R¹ represents a hydrogen atom, a halogen atom, a methyl group, a tert-butyl group, a methoxy group or an ethoxy group.

8. A composition according to claim 1 wherein Y represents a methyl group or an ethyl group.

9. A composition according to claim 1 wherein R² and R³ independently represent a hydrogen atom or a halogen atom.

10. A composition according to claim 1 wherein R⁴ represents a hydrogen atom.

11. A composition according to claim 1 wherein Q represents a substituted or non-substituted C₁-C₂₀-alkyl, a substituted or non-substituted C₂-C₂₀-alkenyl, a substituted or non-substituted C₂-C₂₀-alkynyl, a substituted or non-substituted C₃-C₈-cycloalkyl, a substituted or non-substituted aryl-[C₁-C₈]-alkyl.

12. A composition according to claim 1 wherein Q represents a methyl group, an ethyl group, a n-propyl group, an isopropyl group, a 1,1-dimethylpropyl group, a n-butyl group, an isobutyl group, a sec-butyl group, a tert-butyl group, an isoamyl group, a 1-methylbutyl group, a 2-methylbutyl group, a neopentyl group, a 1-ethylpropyl group, a n-pentyl group, a n-hexyl group, a n-heptyl group, a n-octyl group, a benzyl group or a phenethyl group.

13. A composition according to claim 1 wherein fungicide compound B is selected from the group consisting of:
(B1) benalaxyl, benalaxyl-M, bupirimate, clozylacon, dimethirimol, ethirimol, furalaxyl, hymexazol, metalaxyl, metalaxyl-M, ofurace, oxadixyl and oxolinic acid;
(B2) benomyl, carbendazim, chlorfenazole, diethofencarb, ethaboxam, fuberidazole, pencycuron, thiabendazole, thiophanate, thiophanate-methyl and zoxamide;
(B3) diflumetorim, bixafen, boscalid, carboxin, fenfuram, flutolanil, fluopyram, furametpyr, furmecyclox, isopyrazam (9R-component), isopyrazam (9S-component), mepronil, oxycarboxin, penthiopyrad, sedaxane, thifluzamide, amisulbrom, azoxystrobin, cyazofamid, dimoxystrobin, enestroburin, famoxadone, fenamidone, fluoxastrobin, kresoxim-methyl, metominostrobin, orysastrobin, picoxystrobin, pyraclostrobin, pyribencarb, trifloxystrobin;
(B4) binapacryl, dinocap, fluazinam and meptyldinocap;
(B5) fentin acetate, fentin chloride, fentin hydroxide, silthiofam;
(B6) andoprim, blasticidin-S, cyprodinil, kasugamycin, kasugamycin hydrochloride hydrate, mepanipyrim, pyrimethanil;
(B7) fenpiclonil, fludioxonil, quinoxyfen,
(B8) biphenyl, chlozolinate, edifenphos, etridiazole, iodocarb, iprobenfos, iprodione, isoprothiolane, procymidone, propamocarb, propamocarb hydrochloride, pyrazophos, tolclofos-methyl, vinclozolin,
(B9) aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, viniconazole and voriconazole,
(B10) benthiavalicarb, dimethomorph, flumorph, iprovalicarb, mandipropamid, polyoxins, polyoxorim, prothiocarb, validamycin A, valiphenal,
(B11) carpropamid, diclocymet, fenoxanil, phthalide, pyroquilon, tricyclazole,
(B12) acibenzolar-5-methyl, probenazole, tiadinil,
(B13) bordeaux mixture, captafol, captan, chlorothalonil, copper naphthenate, copper oxide, copper oxychloride, copper preparations such as copper hydroxide, copper sulphate, dichlofluanide, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulphur and sulphur preparations including calcium polysulphide, thiram, tolylfluanid, zineb, ziram,
(B14) 2,3-dibutyl-6-chlorothieno[2,3-d]pyrimidin-4 (3H)-one, ethyl (2Z)-3-amino-2-cyano-3-phenylprop-2-enoate, N-[2-(1,3-dimethylbutyl)phenyl]-5-fluoro-1,3-dimethyl-1H-pyrazole-4-carboxamide, 3-(difluoromethyl)-1-methyl-N-(3′,4′,5′-trifluorobiphenyl-2-yl)-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, (2E)-2-(2-{[6-(3-chloro-2-methylphenoxy)-5-fluoropyrimidin-4-yl]oxy}phenyl)-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, N-(3-ethyl-3,5,5-trimethylcyclohexyl)-3-(formylamino)-2-hydroxybenzamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N-ethyl-N-methyl-N′-{2-methyl-5-(trifluoromethyl)-4-[3-(trimethylsilyl)propoxy]phenyl}imidoformamide, N′-{5-(difluoromethyl)-2-methyl-4-[3-(trimethylsilyl)propoxy]phenyl}-N-ethyl-N-methylimidoformamide, 0-{1-[(4-methoxyphenoxy)methyl]-2,2-dimethylpropyl}1H-imidazole-1-carbothioate, N-[2-(4-{[3-(4-chlorophenyl)prop-2-yn-1-yl]oxy}-3-methoxyphenyl)ethyl]-N²-(methylsulfonyl)valinamide, 5-chloro-7-(4-methylpiperidin-1-yl)-6-(2,4,6-trifluorophenyl) [1,2,4]triazolo[1,5-a]pyrimidine, 5-amino-1,3,4-thiadiazole-2-thiol, propamocarb-fosetyl, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methylsulfonyl)pyridine, 2-butoxy-6-iodo-3-propyl-4H-chromen-4-one, 2-phenylphenol and salts, 3-(difluoromethyl)-1-methyl-N-[2-(1,1,2,2-tetrafluoroethoxy)phenyl]-1H-pyrazole-4-carboxamide, 3,4,5-trichloropyridine-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, quinolin-8-ol, quinolin-8-ol sulfate (2:1) (salt), 5-methyl-6-octyl-3,7-dihydro[1,2,4]triazolo[1,5-a]pyrimidin-7-amine, 5-ethyl-6-octyl-3,7-dihydro[1,2,4]triazolo[1,5-a]pyrimidin-7-amine, benthiazole, bethoxazin, capsimycin, carvone, chinomethionat, chloroneb, cufraneb, cyflufenamid, cymoxanil, cyprosulfamide, dazomet, debacarb, dichlorophen, diclomezine, dicloran, difenzoquat, difenzoquat methylsulphate, diphenylamine, ecomate, ferimzone, flumetover, fluopicolide, fluoroimide, flusulfamide, flutianil, fosetyl-aluminium, fosetyl-calcium, fosetyl-sodium, hexachlorobenzene, irumamycin, isotianil, methasulfocarb, methyl (2E)-2-{2-[({cyclopropyl[(4-methoxyphenyl)imino]methyl}thio)methyl]phenyl}-3-methoxyacrylate, methyl isothiocyanate, metrafenone, (5-chloro-2-methoxy-4-methylpyridin-3-yl)(2,3,4-trimethoxy-6-methylphenyl)methanone, mildiomycin, tolnifanide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(Z)-[(cyclopropylmethoxy)imino][6-(difluoromethoxy)-2,3-difluorophenyl]methyl}-2-phenylacetamide, N-{(E)-[(cyclopropylmethoxy)imino][6-(difluoromethoxy)-2,3-difluorophenyl]methyl}-2-phenylacetamide, natamycin, nickel dimethyldithiocarbamate, nitrothal-isopropyl, octhilinone, oxamocarb, oxyfenthiin, pentachlorophenol and salts, phenazine-1-carboxylic acid, phenothrin, phosphorous acid and its salts, propamocarb fosetylate, propanosine-sodium, proquinazid, pyrrolnitrine, quintozene, S-prop-2-en-1-yl 5-amino-2-(1-methylethyl)-4-(2-methylphenyl)-3-oxo-2,3-dihydro-1H-pyrazole-1-carbothioate, tecloftalam, tecnazene, triazoxide, trichlamide, 5-chloro-N′-phenyl-N′-prop-2-yn-1-ylthiophene-2-sulfonohydrazide, zarilamid, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[2-(1,3-dimethyl-butyl)-phenyl]-5-fluoro-1,3-dimethyl-1H-pyrazole-4-carboxamide, and pentyl {6-[({[(1-methyl-1H-tetrazol-5-yl)(phenyl)methylidene]amino}oxy)methyl]pyridin-2-yl}carbamate.

14. A composition according to claim 13 wherein fungicide compound B is selected from the group consisting of:
(B3) azoxystrobin, boscalid, cyazofamid, fenamidone, fluoxastrobin, pyraclostrobin, trifloxystrobin;
(B4) fluazinam;
(B7) fludioxonil;
(B8) iprodione, propamocarb, propamocarb hydrochloride;
(B9) prothioconazole, tebuconazole, triadimenol;
(B10) benthiavalicarb, iprovalicarb, mandipropamid;
(B13) chlorothalonil, folpet, mancozeb, propineb;
(B14) cymoxanil, fluopicolide, fosetyl-aluminium, propamocarb-fosetylate, bixafen also known as N-(3′,4′-dichloro-5-fluorobiphenyl-2-yl)-3-(difluoromethyl)-1-methyl-1H-pyrazole-4-carboxamide, fluopyram also known as N-{2-[3-chloro-5-(trifluoromethyl)pyridin-2-yl]ethyl}-2-(trifluoromethyl)benzamide and N-[2-(1,3-dimethyl-butyl)-phenyl]-5-fluoro-1,3-dimethyl-1H-pyrazole-4-carboxamide.

15. A composition according to claim 3 wherein insecticide compound D is selected in the list consisting of:
(D1) carbamates, e.g. alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb;
organophosphates, e.g. acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-5-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl, O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, and imicyafos,
(D2) organochlorines, e.g. camphechlor, chlordane, endosulfan, gamma-HCH, HCH, heptachlor, lindane, and methoxychlor;
fiproles (phenylpyrazoles), e.g. acetoprole, ethiprole, fipronil, pyrafluprole, pyriprole, vaniliprole,
(D3) pyrethroids, e.g. acrinathrin, allethrin (d-cis-trans, d-trans), beta-cyfluthrin, bifenthrin, bioallethrin, bioallethrin S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrin (pyrethrum), eflusilanat;
DDT; or methoxychlor,
(D4) chloronicotinyls, e.g. acetamiprid, clothianidin, dinotefuran, imidacloprid, imidaclothiz, nitenpyram, nithiazine, thiacloprid, thiamethoxam, AKD-1022, nicotine, bensultap, cartap, thiosultap-sodium, thiocylam,
(D5) spinosyns, e.g. spinosad and spinetoram;
(D6) mectins/macrolides, e.g. abamectin, emamectin, emamectin benzoate, ivermectin, lepimectin, and milbemectin;
juvenile hormone analogues, e.g. hydroprene, kinoprene, methoprene, epofenonane, triprene, fenoxycarb, pyriproxifen, diofenolan,
(D7) gassing agents, e.g. methyl bromide, chloropicrin and sulfuryl fluoride;
selective antifeedants, e.g. cryolite, pymetrozine, pyrifluquinazon and flonicamid; or
mite growth inhibitors, e.g. clofentezine, hexythiazox, etoxazole,
(D8) diafenthiuron; organotin compounds, e.g. azocyclotin, cyhexatin, fenbutatin oxide; propargite, tetradifon;
(D9) chlorfenapyr, binapacryl, dinobuton, dinocap, DNOC,
(D10) Bacillus thuringiensis strains,
(D11) benzoylureas, e.g. bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron,
(D12) Buprofezin,
(D13) cyromazine,
(D14) diacylhydrazines, e.g. chromafenozide, halofenozide, methoxyfenozide, tebufenozide, and Fufenozide (JS118); azadirachtin,
(D15) amitraz,
(D16) hydramethylnon; acequinocyl; fluacrypyrim; cyflumetofen, cyenopyrafen,
(D17) fenazaquin, fenpyroximate, pyrimidifen, pyridaben, tebufenpyrad, tolfenpyrad, rotenone; Indoxacarb, metaflumizone,
(D18) tetronic acid derivatives, e.g. spirodiclofen and spiromesifen; tetramic acid derivatives, e.g. spirotetramat,
(D19) bifenazate,
(D20) diamides, e.g. flubendiamide, (R),(S)-3-chloro-N¹-{2-methyl-4-[1,2,2,2-tetrafluoro-1-(trifluoromethyl)ethyl]phenyl}-N²-(1-methyl-2-methylsulphonylethyl)phthalamide, chlorantraniliprole (Rynaxypyr), Cyantraniliprole (Cyazypyr),
(D21) amidoflumet, benclothiaz, benzoximate, bromopropylate, buprofezin, chinomethionat, chlordimeform, chlorobenzilate, clothiazoben, cycloprene, dicofol, dicyclanil, fenoxacrim, fentrifanil, flubenzimine, flufenerim, flutenzin, gossyplure, japonilure, metoxadiazone, petroleum, potassium oleate, pyridalyl, sulfluramid, tetrasul, triarathene, verbutine;
4-{[(6-brompyrid-3-yl)methyl](2-fluorethyl)amino}furan-2(5H)-on (known from WO 2007/115644), 4-{[(6-fluorpyrid-3-yl)methyl](2,2-difluorethyl)amino}furan-2(5H)-on (known from WO 2007/115644), 4-{[(2-chlor-1,3-thiazol-5-yl)methyl](2-fluorethyl)amino}furan-2(5H)-on (known from WO 2007/115644), 4-{[(6-chlorpyrid-3-yl)methyl](2-fluorethyl)amino}furan-2(5H)-on (known from WO 2007/115644), 4-{[(6-chlorpyrid-3-yl)methyl](2,2-difluorethyl)amino}furan-2(5H)-on known from WO 2007/115644), 4-{[(6-chlor-5-fluorpyrid-3-yl)methyl](methyl)amino}furan-2(5H)-on (known from WO 2007/115643), 4-{[(5,6-dichlorpyrid-3-yl)methyl](2-fluorethyl)amino}furan-2(5H)-on (known from WO 2007/115646), 4-{[(6-chlor-5-fluorpyrid-3-yl)methyl](cyclopropyl)amino}furan-2(5H)-on (known from WO 2007/115643), 4-{[(6-chlorpyrid-3-yl)methyl](cyclopropyl)amino}furan-2(5H)-on (known from EP-A-0 539 588), 4-{[(6-chlorpyrid-3-yl)methyl](methyl)amino}furan-2(5H)-on (known from EP-A-0 539 588), [(6-chlorpyridin-3-yl)methyl](methyl)oxido-λ⁴-sulfanylidencyanamid, [1-(6-chlorpyridin-3-yl)ethyl](methyl)oxido-λ⁴-sulfanylidencyanamid and its diastereomeres (A) and (B), 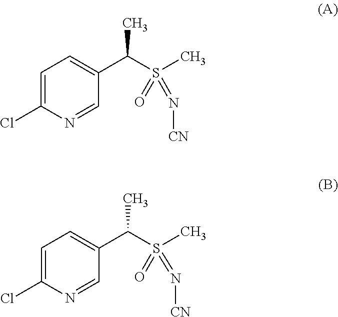
[(6-trifluormethylpyridin-3-yl)methyl](methyl)oxido-λ⁴-sulfanylidencyanamid, or [1-(6-trifluormethylpyridin-3-yl)ethyl](methyl)oxido-λ⁴-sulfanylidencyanamid and its diastereomeres (C) and (D), namely Sulfoxaflor,

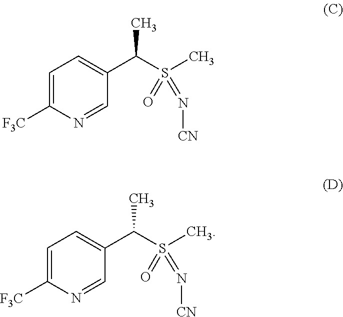

16. A composition according to claim 15 wherein insecticide compound D is selected in the list consisting of imidacloprid and clothianidin.

17. A composition according to claim 1 wherein the A/B weight ratio ranges from 1/0.01 to 1/100.

18. A composition according to claim 17 wherein the A/B weight ratio ranges from 1/0.05 to 1/80.

19. A composition according to claims 2 or 3 wherein the A/B/C or A/B/D weight ratio ranges from 1/0.01/0.01 to 1/100/100.

20. A composition according to claim 19 wherein the A/B/C or A/B/D weight ratio ranges from are for 1/0.05/0.05 to 1/80/80.

21. A composition according to claim 5 wherein the A/B/C/D weight ratio ranges from 1/0.01/0.01/0.1 to 1/100/100/100.

22. A composition according to claim 21 wherein the A/B/C/D weight ratio ranges from 1/0.05/0.05/0.5 to 1/80/80/80.

23. A method for controlling the phytopathogenic fungi or damaging insects of plants, crops or seeds comprising the application of an agronomically effective and substantially non-phytotoxic quantity of a pesticide composition according to claim 1 as seed treatment, foliar application, stem application, drench or drip application or chemigation to the seed, the plant or to the fruit of the plant or to soil or to inert substrate, Pumice, Pyroclastic materials or stuff, synthetic organic substrates organic substrates or to a liquid substrate wherein the plant is growing or wherein it is desired to grow.
